(19) United States
(12) Patent Application Publication
(10) Pub. No.: US 2010/0196643 A1
(43) Pub. Date: Aug. 5, 2010

(54) COOLING JIG FOR EXTRUDING PCTFE STRINGS AND METHOD FOR EXTRUDING PCTFE STRINGS

(75) Inventors: Yves Dugard, Grand Couronne (FR); Eric Leforestier, Aigleville (FR); Ludovic Luce, Rouen (FR); Jerome Chauveau, Evreux (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/524,257

(22) PCT Filed: Jan. 24, 2008
(86) PCT No.: PCT/FR2008/050113

§ 371 Date: Apr. 13, 2010

(30) Foreign Application Priority Data
Jan. 24, 2007 (FR) 0752862

(51) Int. Cl. B29D 23/00; B29C 47/90

(52) U.S. Cl. 428/36.9; 264/209.5

(57) ABSTRACT

The invention relates to a method for making PCTFE strings, that comprises Extruding PCTFE with an extruder connected to an assembly comprising a die and a metallic cooling jig, characterized in that a material is provided between the inner metallic wall of the cooling jig and the PCTFE such that the friction between the PCTFE and this material is lower than the friction between the PCTFE and the metal of the cooling jig.

### FIELD OF THE INVENTION

The present invention relates to a sizing die for the extrusion of PCTFE rods and to a process for manufacturing such rods using said sizing die.

1. Technical Problem

PCTFE is a fluoropolymer comprising, as main monomer, chlorotrifluoroethylene (CTFE), said fluoropolymer being appreciated for its high chemical resistance and its advantageous mechanical and electrical properties. However, it is a difficult polymer to convert, as it requires, unlike other crystalline polymers, particularly high extrusion temperatures (Table 1). The melt viscosity of PCTFE is high even for an extrusion temperature of around 290-300° C., and this does not decrease markedly with the increase in temperature.

TABLE I

| | Tₘ (° C.) | Tₑₓₜᵣᵤₛᵢₒₙ (° C.) |
|---|---|---|
| PCTFE | 215 | >290 |
| PVDF | 170 | 190-260 |

This makes it difficult to extrude PCTFE rods as it is necessary to keep the PCTFE in the melt state at temperatures close to 290-300° C. without thermally degrading it. A “cold” zone (around 160° C.) is liable to result in the formation of a “plug” that prevents continuation of the extrusion and thereby limits productivity.

One problem that the invention is intended to solve is thus to be able to extrude PCTFE rods in a simple and regular manner, with good productivity and without the rods having irregularities. Another problem solved by the invention is to extrude rods without thermal degradation of the PCTFE.

2. Prior Art

U.S. Pat. No. 2,834,054 describes a PCTFE extrusion process which is characterized by a particular extrusion temperature profile.

U.S. Pat. No. 5,833,070 describes a process for extruding PCTFE in film or sheet form, consisting in subjecting the melt to a quench.

In neither of these two documents is the process of the invention described.

### FIGURES

FIG. 1 shows an assembly 1 formed from an extrusion die 3 and a sizing die 2. The zone A (sizing die) is cooled by means of a cooling circuit 4 in which a heat-transfer fluid circulates, and the zone B (extrusion die) is kept at a high temperature by means of a heater band 7. A thermal insulator 5 is placed between the extrusion die 3 and the sizing die 2. The sizing die comprises a tube 6 formed from a material against which the rod slides. The molten material enters the extrusion die 3 and emerges via the sizing die 2 (see the direction of the arrows).

FIG. 2 shows the tube 6 removed from the sizing die.

### BRIEF DESCRIPTION OF THE INVENTION

The invention relates to a process for manufacturing PCTFE rods, consisting in extruding PCTFE by means of an extruder connected to an assembly made up of an extrusion die and a metal sizing die, characterized in that a material is placed between the internal metal wall of the sizing die and the PCTFE, said metal being such that the friction of the PCTFE with this material is less than that of the PCTFE with the metal of the sizing die.

### DETAILED DESCRIPTION OF THE INVENTION

The term “PCTFE” is understood to mean a polymer comprising predominantly CTFE units. It may be a CTFE homopolymer or a copolymer of CTFE with at least one other monomer copolymerizable with CTFE, comprising at least 75%, advantageously at least 85% and preferably at least 95% CTFE by weight. One comonomer that can be used is for example vinylidene fluoride (VDF).

The PCTFE of the invention is in the form of a thermoplastic polymer advantageously having a ZST (zero strength time) of between 200 and 450 s, preferably between 300 and 450 s. The ZST is defined according to ASTM D-1430 for characterizing the molecular weight of PCTFE. To give an example of commercial PCTFEs, NEOFLON® M-300P or M-400H grades from the company Daikin or the VOLTALEF® 302 grade from the company Arkema may be used.

The PCTFE may optionally be compounded with at least one additive widely employed in the thermoplastics industry. This may for example be a mineral or organic filler, a pigment or a dye, an antistatic agent, a fire retardant, etc. The PCTFE may also be compounded with at least one other polymer with which it is compatible. This may for example be a fluoropolymer. It is necessary for the additive or the polymer to be thermally stable at the PCTFE extrusion temperatures. The proportion of PCTFE in the compound is at least 80% and advantageously at least 90% by weight.

The PCTFE rod extrusion process consists in extruding the PCTFE (in powder or granule form) by means of an extruder connected to an assembly formed from an extrusion die and the sizing die of the invention.

The purpose of the extrusion die is to feed the melt exiting the extruder into the sizing die and to give the rod its first shape. The extrusion die must keep the polymer in the molten state at a material temperature T>250° C., and without having zones in which the polymer might stagnate. Advantageously, this temperature is greater than 300° C. so as to facilitate the forming operation.

The purpose of the sizing die is to give the melt its shape and to solidify it. It is made of a metal such as, for example, steel. The shape of the sizing die is matched to the shape of the rod that it is desired to obtain. In general, it is desired to produce a cylindrical rod and the sizing die in this case has cylindrical symmetry. The inside diameter of the sizing die is then equal or approximately equal to the outside diameter of the rod. It is also conceivable to obtain other shapes of rod, for example having a square cross section, the sizing die then having the appropriate geometry.

The sizing die has a means for removing heat from the PCTFE so as to solidify the PCTFE before it exits the sizing die.

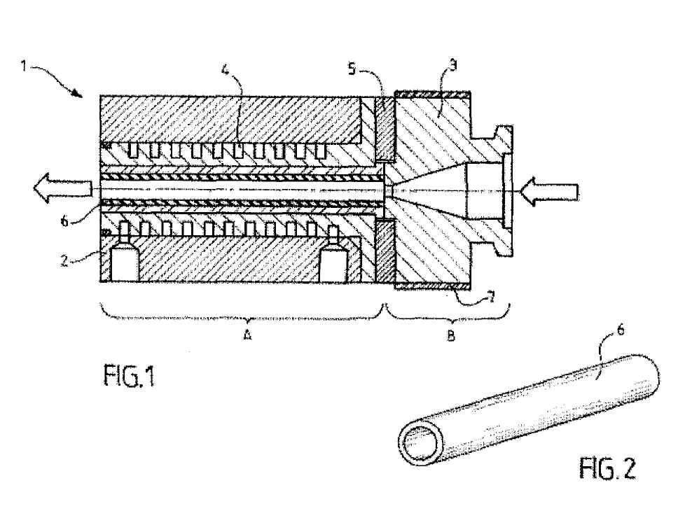

A cooling circuit using a heat-transfer fluid, such as for example a silicone oil, may advantageously be used (see FIG. 1). The heat exchange is such that, at one point on the sizing die, over the entire cross section of the rod, the temperature of the PCTFE is below its crystallization temperature. Preferably, the PCTFE rod exits the sizing die at a temperature of at most 90° C. The cooling over the entire length of the sizing die has a pronounced influence on the crystallinity of the polymer, and therefore on the mechanical properties of the solid PCTFE.

It has been found that there must be no contact between the internal metal wall of the sizing die and the PCTFE since, in this case, extrusion would be very difficult if not impossible, without doubt because the PCTFE, most particularly in the solid or semi-solid state, has a high friction coefficient in contact with the metal surfaces so that the rod can no longer, or practically no longer, progress through the sizing die, thereby retarding or even blocking the extrusion. The use of a lubricant, which could be added to the PCTFE (such as an oil or a grease), is not recommended as its thermal degradation may result in coloring the PCTFE substantially. It is necessary to place a material between the internal metal wall of the sizing die and the PCTFE such that the friction of the PCTFE with this material is less (at the same temperature) than that of PCTFE with the metal of the sizing die. The material may take the form of a tube that can be slipped into the sizing die and against which the rod slides over the entire length of the sizing die (during, of course, the advance of the rod through the sizing die). One effective material for reducing the friction is PTFE (polytetrafluoroethylene). The term “friction” is understood in particular to mean the friction of solid PCTFE rather than liquid PCTFE. The PCTFE/PTFE combination is particularly advantageous since:
the friction between these two fluoropolymers is low; and
PTFE itself has a very high thermal resistance at the envisaged extrusion temperatures.

The invention also relates to the use of said material for improving the production of PCTFE rods, more precisely to the use of a material inside a sizing die such that the friction of the PCTFE with this material is less than that of the PCTFE with the metal of the sizing die.

Advantageously, a thermal insulator may also be placed between the extrusion die and the sizing die so as not to create a “cold” spot at the extrusion die and therefore to keep the PCTFE always in the molten state. The insulator must be capable of withstanding the high temperatures on the extrusion die side and having a low thermal conductivity. For example, the insulator may be made of a composite consisting of a glass cloth, glass mat, roving or mica paper alloyed with at least one resin resistant to high temperatures. For example, the insulator may be PARMITHERM® 41140 sold by the company Isolants de l'Est, ZI Guest, BP 46, 28 avenue des Enables, 54182 Heillecourt, France.

Advantageously, a retarding device may be placed downstream of the sizing die, so as to exert backpressure on the rod. This device makes it possible to compensate for the shrinkage of the polymer as it cools in the sizing die. It also serves to improve the shape of the rod and, in the case of a cylindrical rod, it serves to obtain a perfectly cylindrical shape.

The process of the invention has the following advantages:
high productivity extrusion (no extrusion stoppages);
the rods undergo no degradation (for example, no black color);
the rods show no visible cooling layers; and
in the case of a cylindrical rod, a perfectly cylindrical shape is obtained, thereby requiring little subsequent remachining.

As regards productivity, it has been found that an extruded rod productivity of at least 120 cm per hour for a 17 mm diameter cylindrical rod can be obtained. The processes described above would not enable such a productivity to be obtained.

The process of the present invention applies to PCTFE, but also to the PCTFE-based compound described above.

### EXAMPLES

### Example 1

VOLTALEF® 302 (PCTFE) sold by Arkema having a ZST of between 300 and 450 s was used. The polymer was extruded using a 30 mm COLLIN extruder with the following conditions:
screw speed: 11 rpm;
extrusion temperature profile: 40/280/280/280/280° C.;
extrusion die temperature: 280° C.;
sizing die: 70° C.;
rod diameter: 17 mm;
counterweight: 1000 g on a 250 mm lever arm.

A rod having the following characteristics was obtained:
density: 2.14 g/cm³;
yield stress: 47-49 MPa;
stress at break: 37-40 MPa;
elongation at break: 150-200%;
crystallinity: about 70%.

The extrusion productivity was 120 cm/hour.

### Example 2

VOLTALEF® 302 (PCTFE) sold by Arkema having a ZST of between 300 and 450 s was used. The polymer was extruded using a 30 mm COLLIN extruder with the following conditions:
screw speed: 15-20 rpm;
extrusion temperature profile: 35/280/280/280/280° C.;
extrusion die temperature: 270° C.;
sizing die: 5-50° C.;
rod diameter: 17 mm;
counterweight: 1000 g on a 250 mm lever arm.

A rod having the following characteristics was obtained:
density: 2.13 g/cm³;
yield stress: 46-48 MPa;
stress at break: 37-40 MPa;
elongation at break: 150-200%;
crystallinity: about 70%.

The extrusion productivity was 400-500 cm/hour.

### Example 3

VOLTALEF® 302 (PCTFE) sold by Arkema having a ZST of between 300 and 450 s was used. The polymer was extruded using a §30 mm COLLIN extruder with the following conditions:
screw speed: 12 rpm;
extrusion temperature profile: 35/280/290/290/300° C.;
extrusion die temperature: 300° C.;
sizing die: −18° C.;
rod diameter: 8 mm;
counterweight: 1000 g on a 250 mm lever arm.

A rod having the following characteristics was obtained:
density: 2.12-2.13 g/cm³;
yield stress: 45-47 MPa;
stress at break: 37-40 MPa;
elongation at break: 150-200%;
crystallinity: about 65-70%.

The extrusion productivity was 900 cm/hour.

1. A process for manufacturing polychlorotrifluoroethylene (PCTFE) rods, comprising extruding PCTFE by means of an extruder connected to an assembly (1) comprising an extrusion die (3) and a metal sizing die (2), wherein a material is placed between the internal metal wall of the sizing die (2) and the PCTFE, said metal being such that the friction of the PCTFE with this material is less than that of the PCTFE with the metal of the sizing die (2).

2. The process as claimed in claim 1, in which the PCTFE rod slides over the material.

3. The process as claimed in claim 1, in which a tube (6) formed from the material is placed between the internal metal wall and the PCTFE.

4. The process as claimed in claim 1, in which the material takes the form of a tube (6) placed between the internal metal wall and the PCTFE.

5. The process as claimed in claim 1, in which the material is polytrifluoroethylene (PTFE).

6. The process as claimed in claim 1, in which the sizing die (2) has a means for removing heat from the PCTFE.

7. The process as claimed in claim 1, in which, at one point on the sizing die (2), over the entire cross section of the rod, the temperature of the PCTFE is below its crystallization temperature.

8. The process as claimed in claim 1, in which the temperature of the PCTFE rod on exiting the sizing die (2) is at most 90° C.

9. The process as claimed in claim 1, in which a thermal insulator (5) is placed between the extrusion die (3) and the sizing die (2).

10. The process as claimed in claim 1, in which a retarding device is placed downstream of the sizing die (2), exerting a backpressure on the rod.

11. The process as claimed in claim 1, in which the PCTFE is replaced by a compound based on PCTFE, an additive and/or a polymer, comprising at least 80%, PCTFE by weight.

12. A rod made of PCTFE or of or at least 80% PCTFE, obtained by the process as claimed in claim 1.

13. (canceled)

14. (canceled)

15. (canceled)

16. The process as claimed in claim 11, in which the PCTFE is replaced by a compound based on PCTFE, an additive and/or a polymer, comprising at least 90% PCTFE by weight.
